(19) United States
(12) Patent Application Publication
(10) Pub. No.: US 2005/0032950 A1
(43) Pub. Date: Feb. 10, 2005

(54) Polyacetal and polyvinylbutyral compositions and blends having enhanced surface properties and articles made therefrom

(76) Inventors: Win-Chung Lee, Parkersburg, WV (US); Francis J. Eichstadt, Parkersburg, WV (US); Jerome P. Moraczewski, Kennett Square, PA (US); Shawn Xiang Zhang, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/877,267

(22) Filed: Jun. 25, 2004

Related U.S. Application Data
(60) Provisional application No. 60/483,301, filed on Jun. 28, 2003.
(60) Provisional application No. 60/547,565, filed on Feb. 25, 2004.

(51) Int. Cl. C08K 5/24; C08K 3/34; C08K 3/40

(52) U.S. Cl. 524/261; 524/494; 524/445

(57) ABSTRACT

Toughened polyacetal compositions and blends with low gloss having enhanced surface adhesive properties comprising polyvinylbutyrals are disclosed. Also disclosed are articles of manufacture comprising the polyacetal compositions described herein.

This application claims the benefit of U.S. Provisional Application Ser. No. 60/483301 filed Jun. 28, 2003 and U.S. Provisional Application Ser. No. 60/547565 filed Feb. 25, 2004.

### FIELD OF THE INVENTION

The present invention relates to blends of polyoxymethylene (polyacetal) with polyvinylbutyral (PVB). More particularly, the present invention relates to such blends, processes for the manufacture of such materials, and molded articles prepared therefrom.

### BACKGROUND OF THE INVENTION

Polyoxymethylene compositions are useful as engineering resins due to the physical properties they possess that allow polyoxymethylene to be a preferred material for a wide variety of end-uses. Articles made from polyoxymethylene compositions typically possess extremely desirable physical properties such as high stiffness, high strength and solvent resistance. However because of their highly crystalline surface, such articles exhibit poor adhesion to other materials and it can be very difficult to paint, glue, or print on such surfaces, overmold such articles with thermoplastic polymers or adhere some other type of layer to the surface of the substrate. Furthermore, such articles have high surface gloss, which tends to cause eye irritation from surface reflected light. Low surface gloss tends to impart a more aesthetically pleasing high-grade appearance to the articles.

Polyoxymethylene compositions include compositions based on homopolymers of formaldehyde or of cyclic oligomers of formaldehyde, for example trioxane, the terminal groups of which are end-capped by esterification or etherification, as well as copolymers of formaldehyde or of cyclic oligomers of formaldehyde, with oxyalkylene groups having at least two adjacent carbon atoms in the main chain, the terminal groups of which copolymers can be hydroxyl terminated or can be end-capped by esterification or etherification. The proportion of the comonomers can be up to 20 weight percent. Compositions based on polyoxymethylene of relatively high molecular weight, for example 20,000 to 100,000, are useful in preparing semi-finished and finished articles by any of the techniques commonly used with thermoplastic materials, such as, for example, compression molding, injection molding, extrusion, blow molding, stamping and thermoforming. It can be desirable to enhance the surface adhesion and reduce gloss in polyoxymethylenes.

Plasticized PVB is an adhesive that can be difficult to handle as a feed to a compounding extruder due to its inherent stickiness. Similarly PVB sheet is a material that can be difficult to work with because of the tendency to adhere to itself. Recently it has been found that PVB can be blended with other materials to obtain composites that have a reduced tendency to self-adhere. See for example, WO 02/12356 directed to a process for preparing pellets from PVB scrap material. Heretofore it would not have been possible to obtain suitable blends of PVB and polyoxymethylene polymers.

It has been found that polyacetals compositions that include free-flowing PVB do not have the same degree of toughness as the polyacetals prior to inclusion of the PVB. Use of conventional tougheners, while effective in toughening many thermoplastic polymer compositions, can increase the gloss of an article comprising said tougheners. It is an objective of the present invention to produce low-gloss products, and therefore conventional tougheners that increase gloss are not suitable for use herein. For example, polyurethanes are incorporated in U.S Pat. Nos.: 4,640,949; 4,804,716; 4,845,161; 5,286,807 as tougheners, but also increase gloss. U.S. Pat. Nos. 5,258,431 and 5,484,845 describe polyacetal compositions comprising core shell resin.

It is an object of the present invention to provide PVB-enhanced polyoxymethylene (polyacetal) compositions that have enhanced surface adhesion, that are tough, and that have low surface gloss.

### SUMMARY OF THE INVENTION

In one aspect, the present invention is a thermoplastic polyacetal composition comprising: (a) from about 1 to about 30 weight percent of a free-flowing PVB composite composition comprising from about 20 weight percent to about 95 weight percent polyvinyl butyral (PVB); (b) complimentally, 99 to 24 weight percent polyacetal that is melt processible in a range below about 250° C. and having a number average molecular weight of at least 10,000; (c) optionally a coupling agent in an amount of up to 1.0 weight percent; and (d) optionally, a filler in an amount of up to about 45 weight percent.

In another aspect, the present invention is an article comprising: (a) from about 1 to about 30 weight percent of a free-flowing polyvinyl butyral composition comprising from about 20 weight percent to about 95 weight percent polyvinyl butyral (PVB); (b) from about 99 to about 24 weight percent of a polyacetal that is melt processible in a range below about 200° C. and having a number average molecular weight (Mn) of at least 10,000; (c) optionally a coupling agent in an amount of up to 1.0 weight percent; (d) optionally, a filler in an amount of up to about 45 weight percent, and (e) optionally a core shell resin toughener, wherein the article has a Notched Izod (Nizod) toughness of at least about 1.0 ft-lbs/in² (4.78 kJ/m²), as determined according to ASTM D256 or ISO 180 and a surface gloss of less than about 68%.

In still another aspect, the present invention is a process for preparing a polyacetal composition having a Notched Izod of greater than about 1.0 ft-lbs/in² as determined according to ASTM D256 and a surface gloss of less than about 68% as measured according to either ASTM D523 or ASTM D2457, the process comprising the step of: blending a polyacetal composition with a free-flowing polyvinyl butyral (PVB) composition and a toughener, wherein the PVB composition is included in an amount of from about 1 to about 30 wt % of the total polyacetal composition and wherein the toughener is a core shell resin.

### DETAILED DESCRIPTION OF THE INVENTION

In one embodiment, the present invention is a polyacetal composition having enhanced surface adhesion properties. A composition of the present invention comprises a free-flowing PVB composition, as described in WO 0212356, as a toughener and gloss reducing composition. The teachings of WO0212356 are hereby incorporated by reference. A composition of the present invention comprises from about 1 wt % to about 30 wt %, preferably from about 5 wt % to about 28 wt %, more preferably from about 6 wt % to about 25 wt %, and most preferably from about 7 wt % to about 25 wt % of a free-flowing PVB composition.

The PVB composition of WO 0212356, when included in a thermoplastic polymer composition, can affect the surface properties of an article produced therefrom and lower the gloss on the surface of the article. A plastic surface having low gloss can be a desirable property for articles used in certain applications.

In some instances the PVB composition described in WO 0212356 can act as a toughener of a thermoplastic resin composition. In the practice of the present invention however, when added at levels sufficient to reduce surface gloss, the PVB composition described in WO 0212356 surprisingly can have a detrimental effect on the toughness of the compositions described herein. Therefore, because toughness is a desirable property in a composition of the present invention, an alternate toughener can be added to a polymeric composition of the present invention to produce a polymeric composition having toughness of at least that of the polymeric composition without added PVB. The PVB composition comprises from about 20 to about 95 wt %, preferably from about 40 wt % to about 95 wt %, more preferably from about 60 wt % to about 95 wt %, and most preferably from about 75 wt % to about 95 wt % PVB. The compositions and blends of this invention are prepared by blending the toughener with a polyacetal and optionally a coupling agent and/or other ingredients to produce a toughened polyacetal blend having enhanced surface properties.

The PVB composition comprises at least one component in addition to the PVB. Such other components can be monomeric or polymeric materials, or mixtures thereof. The other components can be selected from polymers and/or monomers that have reactive functionality, or non-reactive polymer and/or monomers such as, for example, polyethylene, polypropylene, polyvinylchloride, nylon, other thermoplastic materials, or mixtures thereof. Preferably the second component is a polymer composition that includes reactive functionality such as anhydride functionality, such as is available commercially from E.I. DuPont de Nemours and Company under the Fusabond® brand name, or carboxylic acid functionality. Fusabond® polymers are polyolefins having anhydride functionality. The other components are present in amounts that are complimentary to the amount of PVB, that is the amount required to account for 100 wt % of the composition.

In another embodiment, the present invention can comprise an inorganic carbonate salt as a gloss reducer. The carbonate salt can be added either in addition to, or as an alternative to the PVB component of the present invention. The carbonate salt can have as a counter ion any metal cation such as one selected from the alkali metal cations, alkaline earth metal ions, or transition metal ions for example. An effective amount of carbonate salt is preferred. As the term is used herein, an “effective amount” is any amount that creates the desired effect. For example, an effective amount of gloss-reducer can be the minimum amount of gloss-reducer that is necessary to reduce the surface gloss of a plastic article to an acceptable level.

In a particularly preferred embodiment, a composition of the present invention comprises, as a toughener, a core shell resin material. The core shell resin material can be prepared according to a process described in an as yet unpublished U.S. Provisional Patent Application entitled “A Process for Making Core Shell Toughener and Toughening Polyoxymethylene Resins”, filed Nov. 3, 2003. Generally, a core shell resin useful in the practice of the present invention can be prepared by carrying out an aqueous phase polymerization of suitable core monomers, followed by polymerization of a shell resin monomer over the core polymer formed in the first step, thereby forming a latex of the core shell resin. The core shell resin is then coagulated from the latex and processed further to produce a suitable core shell toughener for use in the practice of the present invention.

Use of conventional tougheners, while effective in toughening many thermoplastic polymer compositions, can increase the gloss of an article comprising said tougheners. It is an objective of the present invention to produce low-gloss products, and therefore conventional tougheners that increase gloss are not suitable for use herein. The core shell resin toughener described herein can be used in the practice of the present invention without increasing gloss, and in fact can reduce gloss in certain polymeric compositions.

However, the gloss-reducing effect of the core shell resin can be dependent on the resin composition in which it is incorporated. In some cases the core shell does reduce gloss, and in others there is essentially no gloss-reduction. In compositions of particular interest to the applicants the core shell resin used alone is not as effective in reducing gloss as the when the PVB compositions described herein are included. In any event, the gloss-reducing effect of a core shell resin alone is very small relative to the gloss-reducing effect of the PVB composition described herein. Further, the core shell resin is more expensive than the PVB composition, and therefore use of the PVB composition in addition to inclusion of a core shell resin as toughener is much preferred in the practice of the present invention.

Cost of the core shell resin can be a determinative factor in the amount that is included in a composition of the present invention. The core shell resin can be included in any effective amount to produce a polymeric composition comprising the PVB or gloss-reducing component described herein, wherein the toughened polymeric composition has Izod and elongation at break at least as high as the polymer in the absence of the PVB component. In a preferred embodiment, the core shell resin is included in an amount of from about 1 to about 25 wt %, based on the total weight of the low-gloss toughened polymer composition. Preferably, the core shell resin is included in an amount of from about 1 wt % to about 20 wt %, more preferably in an amount of from about 2 wt % to about 18 wt %, and most preferably in an amount of from about 2 wt % to about 16 wt %.

In any event, the core shell resin toughener is added in an effective amount. That is, the toughener can be added in any amount required to impart to a molded part a Notched Izod (Nizod), as determined according to ASTM D256 or ISO 180 of at least about 1.0 ft-lbs/in² (4.78 kJ/m²). Preferably the Nizod is at least about 1.5 ft-lbs/in² (7.17 kJ/m²), and more preferably at least about 2.0 ft-lbs/in² (9.56 kJ/m²). Most preferably, the Nizod is at least about 2.5 ft-lbs/in² (11.95 kJ/m²).

The polyoxymethylene component of the substrate includes homopolymers of formaldehyde or of cyclic oligomers of formaldehyde, the terminal groups of which are end-capped by esterification or etherification, and copolymers of formaldehyde or of cyclic oligomers of formaldehyde and other monomers that yield oxyalkylene groups with at least two adjacent carbon atoms in the main chain, the terminal groups of which copolymers can be hydroxyl terminated or can be end-capped by esterification or etherification.

The polyoxymethylenes used in the substrates of the present invention can be branched or linear and will generally have a number average molecular weight in the range of about 10,000 to 100,000, preferably about 20,000 to about 90,000, and more preferably about 25,000 to about 70,000. The molecular weight can be measured by gel permeation chromatography in m-cresol at 160° C. using a DuPont PSM bimodal column kit with nominal pore size of 60 and 100 A. In general, high molecular weight polyoxymethylenes segregate from the second phase material to a greater degree to the non-polyoxymethylene components, and thus addends may show greater adhesion. Although polyoxymethylenes having higher or lower molecular weight averages can be used, depending on the physical and processing properties desired, the polyoxymethylene weight averages mentioned above are preferred to provide the optimum balance of surface adhesion with other physical properties such as high stiffness, high strength and solvent resistance.

As an alternative to characterizing the polyoxymethylene by its number average molecular weight, it can be characterized by its melt flow rate. Polyacetals that are suitable for use in the blends of the present invention will have a melt flow rate (measured according to ASTM-D-1238, Procedure A, Condition G with a 1.0 mm (0.0413) diameter orifice of 0.1-40 grams/10 minutes). Preferably, the melt flow rate of the polyacetal used in the blends of the present invention will be from about 0.5-35 grams/10 minutes. The most preferred polyacetals with a melt flow rate of about 1-20 gram/10 minutes.

As indicated above, the polyacetals used in the substrates of the present invention can be either a homopolymer, a copolymer or a mixture thereof. Copolymers can contain one or more comonomers, such as those generally used in preparing polyacetal compositions. Comonomers more commonly used include alkylene oxides of 2-12 carbon atoms and their cyclic addition products with formaldehyde. The quantity of comonomers will be no more than 20 weight percent, preferably not more than 15 weight percent, and most preferably about 2 weight percent. The most preferred comonomer is ethylene oxide. Generally, polyacetal homopolymer is preferred over copolymer because of its greater stiffness and strength. Preferred polyacetal homopolymers include those whose terminal hydroxyl groups have been end-capped by a chemical reaction to form ester or ether groups, preferably acetate or methoxy groups, respectively.

The polyacetal may also contain those additives, ingredients, and modifiers that are known to be added to polyacetal compositions for improvement in molding, aging, heat resistance, and the like.

A coupling agent is optionally included in the composition of the present invention. The coupling agent enhances the adhesive surface properties of the toughened polyacetal compositions of the present invention. The coupling agent can be a silane compound. Preferably the coupling compound is selected from the group consisting of: gamma-aminopropyltrimethoxysilane; gamma-aminopropyltriethoxysilane; N-2-aminopropyltrialkoxysilane; or N-(2-aminoethyl)-3-aminopropylmethyldialkoxysilane. When present, the coupling compound is preferably included in an amount of at least about 0.01 wt %. More preferably, the coupling agent is present in an amount of from about 0.1 to about 3 wt %. More preferably, the coupling agent is present in an amount of from about 0.3 wt % to about 2.0 wt %, and most preferably in an amount of from about 0.5 wt % to about 1.5 wt %. The coupling agent can be present as a coating or as a dispersed component in the composition. The coupling agent can function to enhance the adhesion between the toughened polyacetal and a second polymer, such as a thermoplastic elastomer (TPE). TPE's can be desirable because of the soft feel of the polymer, and are also referred to herein as soft touch polymers.

Optional components such as fillers can be present. Fillers can be present in an amount of up to 45 wt %. Particularly preferred are fiber glass-filled polyacetal compositions and/or mineral-filled polyacetal compositions. Suitable mineral fillers are, for example, calcined clay, wollastonite, or talc. Polymeric materials that are non-reactive with the other components may be used as fillers, as well. Polymers useful as fillers in the practice of the present invention include, for example: polyurethane, polyamides, polyesters, and polyacrylates. An antioxidant is not required, however one is preferred. If included, the antioxidant can be present in an amount of at least about 0.1% by weight, and up to an amount where the effect of the antioxidant is optimal.

In another embodiment, the present invention is a process for preparing toughened polyacetal compositions of the present invention. The PVB composition of the present invention can be obtained using the process described in WO 0212356, for example, wherein PVB is combined with a second polymeric component to yield non-blocking pellets having a substantial amount of PVB. PVB is a commercially available product useful for imparting shatter-resistance to glass in myriad applications, among them windshields for automobiles and window glass in homes and buildings. The preparation of PVB is a well-known reaction between aldehyde and alcohol in an acid medium. A plasticizer can be used and is conventional in the process for preparing PVB. Useful plasticizers are known and are commercially available compounds such as, for example, diesters of aliphatic diols with aliphatic carboxylic acids, e.g. tri-ethylene glycol di-2-ethylhexoate (3GO), or tetra-ethylene glycol di-n-heptanoate (4G7). Virgin plasticized PVB sheets (that is, PVB that is obtained first-hand from a manufacturer's roll) can be obtained commercially from DuPont under the brandname of BUTACITE®, for example. PVB can be obtained from other sources, as well, including excess PVB obtained from the edge trim from safety or architectural glass manufacturing operations, PVB recovered from scrap automotive or architectural glass, PVB not considered usable in other commercial applications, and other similar sources or mixtures of these sources. Any of these sources can be satisfactorily used without departing from the spirit and scope of this invention.

In a preferred embodiment, plasticized PVB and three other ingredients: (1) a reactive polymer such as a polymer having anhydride or carboxylic acid functionality; (2) a non-reactive polymer such as polyethylene, polypropylene, or ethylene/n-butyl acrylate/CO terpolymer; and (3) an antioxidant; are mixed in a batch process or a continuous process at an elevated temperature in the range of from about 100° C. to about 280° C., preferably from about 150° C. to about 220° C. to provide a homogeneous melt blend. This blend is dropped to a set of roll mills to mix further and press it into sheet form. A strip of the sheet is continuously fed to an extruder through a belt feeder. In the extruder, the mixture is melted again and pushed through a melt filter to remove any solid contamination. The clean melt is distributed to a die with multiple holes. An under water face cutter cuts those polymers from die face into pellets. The water quenches those pellets while cutting and carries them into a screen to separate them from the bulk water. Wet pellets are dried in a fluidized dryer before pack-out.

The pellets thus obtained can be mixed with suitable polyacetal compositions by melt-blending. For example, the toughened polyacetal blends suitable for use herein can be obtained by melt blending, or melt mixing in any suitable blending or mixing device, such as a Banbury blenders, Haake mixers, Farrell mixers, or extruders. Extruders can be either single screw or twin screw extruders with screws having various degrees of severity. Mixing or blending can be done at a temperature in the range of from about 100° C. to about 250° C., and preferably at a temperature in the range of from about 150° C. to about 230° C.

Toughened polyacetals of the present invention give compressive shear strength (CSS) values of greater than 200 psi, as determined by Compressive Shear tests. CSS is a measure of adhesion. Preferably the CSS is at least 300 psi, and more preferably at least 400 psi. Toughened polyacetals having further enhanced adhesive properties are obtained by further incorporating a coupling or crosslinking agent with the toughened polyacetal. For example, a coupling agent such as Silquest A-1100® (gamma-aminopropyltriethoxysilane), which is commercially available from Crompton Corp., can be incorporated by either inclusion into the bulk of the toughened polyacetal composition, or by coating the surface of the toughened polyacetal composition. The coupling compound can be incorporated in either manner as an aqueous solution. The pH of the solution can be lowered using an acid such as acetic acid or citric acid, for example.

In another embodiment, the present invention is an article obtained from the polyacetal compositions of the present invention. Articles of the present invention include laminate articles, shaped articles, etc. Laminates comprising the polyacetal compositions of the present invention can be incorporated into various other articles such as, for example, cars, trains, automobiles, appliances, boats, acoustic tiles, acoustic flooring, walls, ceilings, roofing materials or other articles where sound damping, low surface gloss, and/or tough polymers are desirable.

In the practice of the present invention, % gloss for a surface is determined according to ASTM D-523, modified as described hereinbelow. A gloss measurement can be dependent on whether optional filler, such as glass for example, is present or not. Low surface gloss for a surface comprising a polyacetal composition of the present invention, wherein the composition comprises no optional filler, is a gloss measurement of less than 68%. Preferably, a surface comprising an unfilled polyacetal composition of the present invention has a gloss of less than about 65%, and more preferably less than about 60%. Polyacetal resins can optionally comprise a color additive or a pigment, such as for example carbon black. Polyacetal compositions that include colorants can inherently have lower gloss than similar compositions without a colorant.

In a conventional polyacetal composition that includes filler, the surface gloss is reduced relative to a non-filled conventional polyacetal composition. In a conventional polyacetal composition, the higher the percentage of filler, the lower the gloss. In a filled-polyacetal composition of the present invention, however, % gloss is reduced relative to a filled conventional polyacetal composition having similar filler content. The effect is that lowering the total amount of filler in a filled composition of the present invention can reduce the surface gloss, rather than increase the gloss as in a conventional polyacetal composition. A filled composition of the present invention comprising at least about 1 wt % filler to about 10 wt % filler has less than 50% gloss. Filled polyacetal compositions of the present invention having at least about 10% filler to about 20% filler have gloss of less than 20%. Filled polyacetal compositions of the present invention having at least about 20% filler to less than 25% filler have gloss of less than or equal to about 16% gloss. The reduction of gloss in compositions having greater than 25% filler may be less substantial as the amount of filler increases.

In a particularly preferred embodiment, polyacetal compositions of the present invention can be laminated to other polymeric materials, such as thermoplastic elastomers (TPEs). TPEs are thermoplastic materials that have rubber-like properties and are polymers that are soft to the touch. However, TPEs do not generally have good adhesion to rigid polymers. TPE laminates with the polyacetals of the present invention would eliminate this adhesion problem in many cases.

In another preferred embodiment, the polyacetal compositions of the present invention can be laminated with PVB to yield PVB laminates having substantial sound reduction properties.

In still another embodiment, laminates having at least two sheets comprising a polyacetal composition of the present invention adhered on the opposite surfaces of a PVB interlayer have improved and structural strength relative to one sheet of the polyacetal having twice the thickness of the laminate polyacetal sheets. Such laminates can find use in car door panels, boat hulls, or other similar uses to impart structure and strength.

In still another embodiment the polyacetal compositions of the present invention can be used to hold onto glass fibers that are on or near the surface of articles comprising fiber-glass filled polyacetal compositions.

### EXAMPLES

### Examples 1 to 5 and Control Example C1

### Extrusion Process to Produce Polymer Blends and Physical Properties of the Blends

ECOCITE™ (free flowing PVB pellets as prepared according to WO 0212356, available from E.I. DuPont de Nemours and Company (DuPont)). was melt blended together with natural color Delrine 500. Delrin® grade products are available from DuPont. The mixture was premixed before being compounded by melt-blending in a 28 mm Werner & Pfleiderer co-rotating twin screw extruder at a melt temperature below 230° C. The screw speed was 200 rpm and the total extruder feed rate was 15 pounds per hour.

The resulting strand was quenched in water, cut into pellets, and sparged with nitrogen until cool. Tensile bars were obtained by injection molding according to ISO 294 and measured for: Notched Izod (Nizod) by ISO 180; % Elongation at Yield (% EL-Y) by ISO 527; Elongation at Break (EL-B) by ISO 527; Tensile Strength (TS) by ISO 527; Flexural Modulus (F.Mod) by ISO 178; Compressive Shear Strength (CSS); and % Gloss by ASTM D523. The results are recorded in Table 1.

### Modified Compressive Shear Stress (CSS) Test for Adhesion Force of Laminated Polymer Plate

Square (5″×5″) plaques of 2 mm thickness were molded in an injection molding machine according to ISO test method 294. PVB sheeting was sandwiched between two plagues in a humidity controlled room (relative humidity: 23% RH). After being autoclaved at 135° C. for 20 minutes, the 5″×5″ laminated polymer plate was cut to obtain six 1″×1″ squares from the center plate. The six squares were dried in a vacuum oven at 60° C. overnight. Each square was sheared at 45-degree angle in an Instron in a humidity controlled room (relative humidity: 50% RH). Force in pound per inch required to shear the square apart (CSS) was recorded. Average of those six squares and standard deviation were calculated for each sample and recorded in Table 1.

### Gloss Measurement

% Gloss reported in Table 1 was measured at 60 degrees by a modified ASTM D-523 method using a Novo-Gloss Meter made by Macbeth. The measurement followed ASTM D-523 except gloss was measured at the center of a 18 mm×29 mm end tab on two ISO bars and averaged. Gloss was measured on the non-gated end of the bars in order to prevent gate smear from influencing the measurement.

TABLE 1

| | Ex. 1 | Ex. 2 | Ex. 3 | Ex. 4 | Ex. 5 | C1 |
|---|---|---|---|---|---|---|
| ^{a}Ecocite ™ | E: 3% | G: 3% | H: 3% | H: 5% | H: 10% | None |
| (Grade: wt %) | | | | | | |
| Melt Flow Rate | 13.5 | 13.5 | 13.4 | 12.2 | 9.4 | 14.2 |
| Nizod (KJ/M²) | 6.53 | 6.42 | 7.14 | 6.06 | 4.22 | 7.84 |
| % EL-Y | 11 | 14.2 | 14.5 | 13.5 | 12.4 | 18 |
| % EL-B | 25.2 | 31.5 | 28.6 | 26.3 | 22.4 | 43.5 |
| TS-Kpsi | 9.9 | 9.8 | 9.8 | 9.5 | 8.5 | 10.3 |
| F.Mod- kpsi | 433 | 430 | 430 | 413 | 370 | 454 |
| Ave CSS | 419.7 | | | | | 330.9 |
| Std Dev CSS | 191.7 | | | | | 83.4 |
| % Gloss | 63 | 67 | 59 | 46 | 27 | 73 |

^{a}E, G, and H are grades of Ecocite ™ commercially available from DuPont.

### Examples 6 to 9 and Comparative Examples C2 & C3

The same process, procedures, and test methods in above Examples 1 to 5, & C1 were used for Examples 6-9 and Comparative Examples C2 and C3 in Table 2 except: (a) Delrin® 500 was replaced with Glass Filled natural color Delrin® 570 in Ex 6, Ex 7 & C2 and with natural color 525GR for Ex 8, Ex 9 & C3; (b) instead of a twin screw extruder, a 2 inch single screw extruder from Killion was used to melt blend the premixed mixture at ˜230° C. melt temperature; and (c) the screw speed was 100 rpm and the total extruder feed rate was 75 pounds per hour.

TABLE 2

| | Ex 6 | Ex 7 | C2 | Ex 8 | Ex 9 | C3 |
|---|---|---|---|---|---|---|
| | Glass Filled Delrin ® 570 | | | Delrin ® 525GR | | |
| Ecocite ™ | H: 8% | H: 12% | None | H: 8% | H: 12% | None |
| (Grade: wt %) | | | | | | |
| % Glass | 18.5 | 17.9 | 20 | 23 | 22 | 25 |
| Melt Flow Rate | 8.7 | 8.7 | 8.4 | 11.3 | 10.2 | 12.2 |
| Nizod-KJ/M2 | 3 | 2.8 | 3.8 | 4.63 | 3.81 | 7.45 |
| % ELYC50 | 9.4 | 9.1 | 9.5 | .7 | 4.2 | 1.7 |
| % EL-B | 9.3 | 9.5 | 9.6 | 4 | 3.6 | 4.6 |
| TS-B, MPa | 51.2 | 47 | 60.6 | 101.5 | 87.5 | 132.2 |
| F.Mod- MPa | 3984 | 3515 | 4991 | 6325 | 5818 | 7877 |
| FL STR, MPa | 84 | 74 | 106 | — | — | — |
| Ave CSS | 1366.6 | 1331.4 | 1190.2 | — | — | — |
| Std Dev CSS | 370.8 | 246.5 | 69.1 | — | — | — |
| % Gloss | 18.4 | 9.3 | 25.9 | 16.0 | 15.8 | 16.7 |

### Examples 10 to 13 and Comparative Examples C4 & C5

ECOCITE™ and polyacetal copolymer D460 NC010 (Delrin® 460, natural color) & D460BK (Delrin® 460, black) were pre-blended before being melt blended in a 34 mm Leistritz twin screw extruder at less than 210° C. melt temperature. The screw speed was 200 rpm and the total extruder feed rate was 30 pounds per hour. Otherwise, the procedures used for Examples 1 to 5, & C1 were used for Examples 10 to 13 and Comparative Example C3 and C4. The blends were evaluated using the test methods described hereinabove and the results reported below in Table 3.

TABLE 3

| | Ex 10 | Ex 11 | C4 | Ex 12 | Ex 13 | C5 |
|---|---|---|---|---|---|---|
| | D460 NC010 | | | D460 BK (carbon black) | | |
| Ecocite ™ H | 8 | 12 | 0 | 8 | 12 | 0 |
| (wt %) | | | | | | |
| Melt Flow Rate | 9.8 | 9.5 | 10.1 | 10.7 | 9.9 | 11.3 |
| Nizod-KJ/M2 | 6.8 | 5.6 | 7.4 | 6.3 | 5.6 | 7.8 |
| % EL-Y | 13.3 | 13.8 | 10.6 | 13.1 | 14 | 11 |
| % EL-B | 52.8 | 44.2 | 39.3 | 57.8 | 45 | 36 |
| TS-Mpa | 53.7 | 49.9 | 63.3 | 54.4 | 50.8 | 63.3 |
| F.Mod- MPa | 2244 | 2087 | 2716 | 2267 | 2114 | 2698 |
| Ave CSS | 397.4 | 505.5 | 461.2 | 524.3 | 468.4 | 242.6 |
| Std Dev CSS | 73.7 | 135.8 | 238.7 | 133.8 | 138.2 | 102.1 |
| % Gloss | 53.2 | 43.0 | 74.6 | 42.1 | 37.9 | 68.2 |

### Examples 14 to 22, and Comparative Examples C5 to C7

ECOCITE™ and polyacetal copolymer D460 NC01 0 were pre-blended before being melt blended in a 34 mm Leistritz twin screw extruder at less than 210° C. melt temperature. The screw speed was 200 rpm and 20 the total extruder feed rate was 30 pounds per hour. Otherwise, the procedures used for Examples 1 to 5, & C1 were used for Examples 14 to 22 and Comparative Example C5 to C7. The blends were evaluated using the test methods described hereinabove and the results reported below in Table 4.

TABLE 4

| | | Elongation | Nizod | 60° Gloss |
|---|---|---|---|---|
| Example | Composition | (Break, %) | (kJ/m²) | (Avg. of 2) |
| C5 | A | 35.1 | 7.00 | 64.2 |
| 14 | A¹ + 1^{a} | 34.2 | 4.91 | 45.8 |
| 15 | A + 2^{b} | 58.6 | 7.70 | 33.5 |
| 16 | A + 3^{c} | 104.3 | 13.0 | 42.3 |
| C6 | B² | 31.5 | 5.51 | 67 |
| 17 | B + 1 | 28.3 | 3.24 | 41 |
| 18 | B + 2 | 35.0 | 6.32 | 26.1 |
| 19 | B + 3 | 52.9 | 8.95 | 30 |
| C7 | D³ | 50.3 | 8.55 | 60.9 |
| 20 | D + 1 | 27.4 | 4.29 | 36.8 |
| 21 | D + 2 | 40.1 | 6.12 | 37.5 |
| 22 | D + 3 | 51.3 | 7.52 | 41.3 |

¹Delrin ® 460 NC010
²Derin ® 1260 NC010
³Delrin ® 500 NC010
^{a}15 wt % Ecocite ™ H;
^{b}15 wt % Ecocite ™ H + 10 wt % DuPont core shell (CS) resin;
^{c}15 wt % Ecocite ™ H + 20 wt % DuPont CS resin

### Examples 23 through 30

ECOCITE™ and polyacetal copolymer were pre-blended before being melt blended in a 30 mm Werner-Pfleiderer twin screw extruder at less than 210° C. melt temperature. The screw speed was 200 rpm and the total extruder feed rate was 30 pounds per hour. Brown pigment (Clariant Brown 9648 Concentrate) was added at a loading of 4 wt %. Otherwise, the procedures used for Examples 1 to 5, & C1 were used for Examples 23 to 30. The blends were evaluated for: Notched Izod (Nizod) by ASTM D246; % Elongation at Break (EL-B) by ASTM D638; and % Gloss by ASTM D2457. The results are recorded in Table 5.

TABLE 5

| | Composition | Elongation | Nizod | Nizod | 60° |
|---|---|---|---|---|---|
| Ex | (wt %) | (Break, %) | (ft-lbs/in²) | (kJ/m²) | Gloss |
| 23 | F + 15% H + 15% CS | 55.3 | 2.12 | 10.13 | 12.2 |
| 24 | F + 20% H + 5% CS | 37.6 | 1.42 | 7.79 | 11.6 |
| 25 | F + 25% H + 5% CS | 37.9 | 1.41 | 6.74 | 11.1 |
| 26 | F + 25% H + 15% CS | 62.5 | 2.16 | 10.32 | 12.2 |
| 27 | F + 20% H + 15% CS | 59.5 | 2.05 | 9.80 | 12.3 |
| 28 | G + 20% H + 0% CS | 28.7 | 1.35 | 6.45 | 4.9 |
| 29 | G + 20% H + 10% CS | 41.9 | 1.70 | 8.13 | 4.8 |
| 30 | G + 25% H + 10% CS | 41.2 | 1.64 | 7.84 | 4.6 |

F = Delrin ® 460 NC010;
G = Delrin ® 300 NC010;
H = Ecocite ™ H;
CS = DuPont core shell resin.

1. A thermoplastic polyacetal composition comprising: (a) from about 1 to about 30 weight percent of a free-flowing gloss-reducing composition comprising from about 20 weight percent to about 95 weight percent polyvinyl butyral (PVB); (b) complimentally, 99 to 24 weight percent polyacetal that is melt processible in a range below about 250° C. and having a number average molecular weight (Mn) of at least 10,000; (c) optionally a coupling agent in an amount of up to 1.0 weight percent; and (d) optionally, a filler in an amount of up to about 45 weight percent.

2. The composition of claim 1 wherein the PVB of the gloss-reducing composition is selected from virgin PVB, scrap PVB, virgin plasticized PVB, scrap plasticized PVB, edge trim PVB, plasticized PVB recovered from windshield, and mixtures thereof.

3. The composition of claim 1 wherein said gloss-reducing composition further comprises one or more polymers having anhydride functionality and/or one or more polymers having carboxylic acid functionality.

4. The composition of claim 1 wherein said gloss-reducing composition further comprises a non-reactive polymer.

5. The composition of claim 4 wherein said non-reactive polymer is selected from polymers in the group consisting of core shell resins, polyethylene, polypropylene, polyvinylchloride, nylon, olefinic copolymers, and mixtures thereof.

6. The composition of claim 1 wherein the filler (d) is a filler selected from fillers in the group consisting of: fiber glass; a mineral selected from calcined clay, wollastonite, or talc; or another polymer compatible with polyacetal in use, such as polyurethane, polyamide or polyarylate.

7. The composition of claim 1 wherein the coupling agent is an aminofunctional silane.

8. The composition of claim 1 wherein the polyacetal (b) is a branched or linear polyoxymethylene polymer.

9. The composition of claim 1 further comprising at least 0.1 weight percent of an antioxidant.

10. An article comprising: (a) from about 1 to about 30 weight percent of a free-flowing polyvinyl butyral composition comprising from about 20 weight percent to about 95 weight percent polyvinyl butyral (PVB); (b) from about 99 to about 24 weight percent of a polyacetal that is melt processible in a range below about 200° C. and having a number average molecular weight (Mn) of at least 10,000; (c) optionally a coupling agent in an amount of up to 1.0 weight percent; (d) optionally, a filler in an amount of up to about 45 weight percent, and (e) optionally a core shell resin toughener, wherein the article has a Notched Izod (Nizod) toughness of at least about 1.0 ft-lbs/in² (4.78 kJ/m²), as determined according to ASTM D256 or ISO 180.

11. The article of claim 10 wherein the article is a laminate comprising a layer of PVB sheeting as interlayer, wherein the laminate has a Compressive Shear Stress (CSS) greater than 200 pounds per square inch (psi).

12. The article of claim 11 further comprising a coating of an amino-functional silane.

13. The article of claim 12 wherein the amino-functional silane is an amino-silane selected from the group consisting of: 3-aminopropyltrialkoxysilane; gamma-aminopropyltrimethoxysilane; gamma-aminopropyltriethoxysilane, N-2-aminopropyltrialkoxysilane; and N-(2-aminoethyl)-3-aminopropylmethyldialkoxysilane.

14. The article of claim 10 further comprising a layer of a thermoplastic elastomeric (soft touch) polymer.

15. The article of claim 10 having a CSS of greater than 200 psi, wherein the toughened polyacetal polymer forms at least one outer layer of the laminate, and the laminate interlayer comprises a sheet of PVB.

16. An article comprising the laminate of claim 15.

17. The article of claim 16 wherein the laminate comprises a polymer as the second outer layer of the laminate.

18. The article of claim 17 wherein the polymer is selected from the group consisting of: polyamides; polyesters; polycarbonates; polyarylates; and polyacetals.

19. The laminate article of claim 18 wherein the second outer layer of the laminate comprises a second layer of the toughened polyacetal composition.

20. The article of claim 19 wherein the article is: a boat; a car; a train; an airplane; a roof; a wall; a building; a wall; a ceiling; a floor; a tool; an appliance.

21. The article of claim 10 wherein the article is formed by an injection molding or a press molding process.

22. The article of claim 10 having no filler and a surface gloss of less 68%.

23. The article of claim 10 having less than 20 wt % filler and a gloss of less than 20%.

24. The article of claim 23 having less than 25 wt % filler and a gloss of less than 16%.

25. The article of claim 24 comprising at least about 1 wt % core shell resin, said percentage based upon the total weight of the composition.

26. The article of claim 25 wherein the article comprises at least about 3 wt % core shell resin.

27. The article of claim 26 wherein the article comprises at least about 5 wt % core shell resin.

28. The article of claim 27 wherein the article comprises at least about 7 wt % core shell resin.

29. The article of claim 28 wherein the article comprises at least about 10 wt % core shell resin.

30. The article of claim 29 wherein the article comprises from about 1 wt % to about 25 wt % core shell resin.

31. A process for preparing a polyacetal composition having a Notched Izod of greater than about 1.0 ft-lbs/in² (4.78 kJ/m²) as determined according to ASTM D256 and a surface gloss of less than about 68% as measured according to either ASTM D523 or ASTM D2457, the process comprising the step of: blending a polyacetal composition with a free-flowing polyvinyl butyral (PVB) composition and a toughener, wherein the PVB composition is included in an amount of from about 1 to about 30 wt % of the total polyacetal composition and wherein the toughener is a core shell resin.
